(19) United States
(12) Patent Application Publication
(10) Pub. No.: US 2004/0042210 A1
(43) Pub. Date: Mar. 4, 2004

(54) Work surface lighting

(75) Inventors: Hans Gerd Keller, Sundern (DE); Michael Schindler, Forst (DE)

Correspondence Address: John T. Winburn, BSH Home Appliances Corporation, 100 Bosch Blvd, New Bern, NC, 28562, US

(73) Assignee: BSH Bosch und Siemens Hausgerate GmbH, Munich (DE)

(21) Appl. No.: 10/441,589

(22) Filed: May 19, 2003

(30) Foreign Application Priority Data
Nov. 21, 2000 (DE) 20019737.1

(51) Int. Cl. F21V 33/00

(52) U.S. Cl. 362/253; 362/96; 362/295

(57) ABSTRACT

A work surface lighting arrangement for lighting the work surface under an extractor hood, such as a cooking surface in a kitchen area. The lighting arrangement includes at least two lights in the hood with one light being user activated and the second activated by operation of the hood. The lights can include a dimming function and the second light can be activated with the hood exhaust fan. The second light also can be activated only after activation of the first light.

The invention relates to lighting for a work surface beneath an extractor hood, wherein the lighting means are arranged in the extractor hood, and can be switched on and off by means of a switch.

Such applications are known for the kitchen area, where an extractor hood with lamps is arranged over the cooking surface to light the cooking surface. Lighting normally takes place with two or more lamps actuated via a switch. This switch is located directly on the extractor hood, or linked with the actuation of extraction units from the extractor hood.

The disadvantage to these types of cooking surface lighting means is that the luminous intensity, and hence the power consumption, is constant when switched on, even though this luminous intensity is not continuously required over the period of use. This holds true in particular when the cooking surface lighting is also used for lighting a room independently of cooking.

To resolve this energy problem, U.S. Pat. No. 5,690,093 proposes a circuit in an extractor hood that makes it possible to regulate the fan speed and luminous intensity within broad limits. This is done by making the appropriate inputs via an array of strips with contact switches on the front of the extractor hood. A diminished nighttime lighting can be set as well.

EP 1 039 235 A2 discloses a cooking surface with extractor hood arranged over it, in which a moving hand or dish turns on the lamps and regulates the fan speed by way of a virtual wall at the front edge of the extractor hood. A time-dependent circuit turns off the lamps again and reduces the fan speed after a certain period.

The disadvantage to these devices is that they make extractor hoods more expensive, and require additional user programming. This is why an operating state often becomes a permanent state once set, and the achievable energy effect is lost.

The object of the invention is to make a work surface under an extractor hood gradually adjustable in an easy manner.

This object is achieved with the characterizing features of claim 1; the subclaims describe advantageous embodiments.

In the work surface lighting under an extractor hood according to the invention, in which at least two lamps are located for lighting the work surface and can be switched on and off with a switch, it is provided that the user be able to directly switch one or more lamps on and off using a light switch arranged on the extractor hood, and that one or more additional lamps are switched on or off via a switch that can be actuated by starting up/shutting down the extractor hood.

This device provides for a work surface lighting under an extractor hood that can be incrementally adjusted without any problem by the user in a very simple manner.

In one preferred embodiment, the switch coupled with the startup/shutdown of the extractor hood can be actuated by retracting or inserting an extraction unit that improves the exhaust function of the extractor hood.

In another variant, the switch coupled with the startup/shutdown of the extractor hood can be actuated by the on/off switch of the exhaust hood fan.

During the process of cooking and concurrent venting, both embodiments ensure a complete lighting of the cooking surface, the work surface under the extractor hood.

It is also possible to use one or more lamps to be switched on and off by the user for lighting a room.

To ensure that the lamp to be switched on and off by the user is always switched on first, the invention provides an embodiment in which the switch to be operated directly by the user is wired with the switches that can be actuated during startup/shutdown in such a way that it being switched on is a precondition for actuating the activation function of the other switch(es). In this way, the lighting can be completely deactivated given sufficient daylight.

In addition, one preferred embodiment provides that the light switch that the user can directly switch on and off, and/or the switch that can be actuated by starting up/shutting down the extractor hood, includes a dimming function for gradually adjusting the luminous intensity of the lamp(s) actuated with the respective switch. This makes it possible to set any illumination intensity under the extractor hood.

1. A work surface lighting under an extractor hood, in which at least two lamps are located for lighting the work surface and can be switched on and off with a switch, characterized in that the user can directly switch one or more lamps on and off using a light switch arranged on the extractor hood, and that one or more additional lamps are switched on or off via a switch that can be actuated by starting up/shutting down the extractor hood.

2. The work surface lighting according to claim 1, characterized in that the switch coupled with the startup/shutdown of the extractor hood can be actuated by retracting or inserting an extraction unit that improves the exhaust function of the extractor hood.

3. The work surface lighting according to claim 1, characterized in that the switch coupled with the startup/shutdown of the extractor hood can be actuated by an on/off switch of the extractor hood fan.

4. The work surface lighting according to at least one of claims 1 to 3, characterized in that the switch to be operated directly by the user is wired with the switches that can be actuated during startup/shutdown in such a way that it being switched on is a precondition for actuating the activation function of the other switch(es).

5. The work surface lighting according to at least one of claims 1 to 4, characterized in that the light switch that the user can directly switch on and off, and/or the switch that can be actuated by starting up/shutting down the extractor hood, includes a dimming function for gradually adjusting the luminous intensity of the lamp(s) actuated with the respective switch.
